(19) United States
(12) Patent Application Publication
(10) Pub. No.: US 2022/0060867 A1
(43) Pub. Date: Feb. 24, 2022

(54) WIRELESS SENSOR DEVICE, HOST DEVICE, AND METHOD OF CONTROLLING LOW-POWER OPERATION OF WIRELESS SENSOR DEVICE

(71) Applicant: SEMES CO., LTD., Cheonan-si (CN)

(72) Inventors: Sang Hyun SON, Busan (KR); Yong Jun SEO, Hwaseong-si (KR); Dong Ok AHN, Anyang-si (KR)

(73) Assignee: SEMES CO., LTD., Cheonan-si (KR)

(21) Appl. No.: 17/085,913

(22) Filed: Oct. 30, 2020

(30) Foreign Application Priority Data
Oct. 31, 2019 (KR) 10-2019-0137481

(51) Int. Cl. H04W 4/38; H04W 52/02

(52) U.S. Cl. CPC H04W 4/38; H04W 52/0235

(57) ABSTRACT

A method of controlling a low-power operation of a wireless sensor device includes performing a sensor-active step where the wireless sensor device is active during the time taken for a working mode in which the wireless sensor device performs multiple tasks, and performing a sensor-inactive step where a mode of the wireless sensor device is switched to a sleep mode after the working mode is ended. The performing of the sensor-active step includes receiving, after transmitting sensing data of a sensing target to a host device that monitors and controls the wireless sensor device, operation control information stored in the host device from the host device.

### CROSS REFERENCE TO RELATED APPLICATION

The present application claims priority to Korean Patent Application No. 10-2019-0137481, filed Oct. 31, 2019, the entire contents of which are herein incorporated by reference.

### BACKGROUND OF THE INVENTION

### Field of the Invention

The present disclosure relates to a wireless sensor device, a host device, and a method of controlling low-power operation of the wireless sensor device. More particularly, the present disclosure relates to a method that fulfills the following: in a wireless sensor device operating between a working mode and a sleep mode for low power operation, the time taken for the working mode of the wireless sensor device is kept to a minimum, and when the wireless sensor device transmits information on sensing data, a host device transmits operation control information stored therein, whereby the reception success rate of the operation control information is maximized while the wireless sensor device operates with low power.

### Description of the Related Art

In various technical fields, such as factory automation technology, crime prevention technology, home automation technology, and the like, a physical quantity with respect to a sensing target is measured through various types of sensors depending on the form of each sensing target and types of sensing data, and a result of measurement is used via a host device.

In the related art, a sensor system has been constructed that connects various sensor devices to a host device in a wired form of which physical implementation is simple. However, due to various reasons, such as manufacture of the devices in a small and slim size, the distance between the sensor device and the host device, complexity of a wired configuration, and the like, the use of a wireless sensor system that employs a wireless mobile sensor device has increased rapidly.

In the case of the wireless mobile sensor device, the usage capacity of the sensor device is limited because power is supplied from an internal battery rather than an external power source due to various constraints, such as installation convenience, installation location, and the like. In order to manufacture the sensor device in a small size, the capacity of the battery cannot be greatly increased.

FIG. 1 is a diagram illustrating an embodiment of operation of a conventional wireless sensor system.

The wireless sensor system may be schematically composed of a host device 10 and wireless sensor devices 20a. The host device 10 monitors and controls the wireless sensor devices, and the wireless sensor devices 20a are installed in a distributed manner to measure a sensing target 30.

The wireless sensor system measures the physical quantity with respect to the sensing target 30 at regular period intervals and controls various situations on the basis of a result of the measurement. The wireless sensor device 20a senses the sensing target 30 at step S11 according to an n-th sensing period and then transmits sensing data to the host device 10 at step S13. Then, the host device 10 provides sensing information to a user or a higher-level device managing the overall situation at step S15, receives operation control information for the wireless sensor device 20a accordingly at step S21, and gives a command to the wireless sensor device 20a at step S22. According to the command of the host device 10, the wireless sensor device 20a performs an operation at step S23.

Herein, during an n-th sensing period, which is one sensing period, multiple pieces of operation control information may be input at steps S21, S24, and S27. Each time the operation control information is input, the host device 10 gives a corresponding command to the wireless sensor device 20a at steps S22, S25, and S28. The wireless sensor device 20a performs an operation according to each command at steps S23, S26, S29.

In addition, the above-described process is repeatedly performed during an n+1-th sensing period, which is the subsequent sensing period. The operation shown in FIG. 1 enables a user's commands to be immediately carried out, but accordingly, the wireless sensor device 20a needs to be kept in an active state at all times. Therefore, the power consumption of the wireless sensor device 20a is considerably large so that it is necessary to frequently charge or replace the battery.

In order to solve such a problem, a method has been proposed in which a wireless sensor device operates switching between an active state and an inactive state and a duty cycle, which is the degree of maintenance of the active state, is adjusted during a sensing period.

FIG. 2 is a diagram illustrating an embodiment of an operation of adjusting a duty cycle of a wireless sensor system in the related art.

As shown in FIG. 2, while a wireless sensor device 20b operates in an working mode at step S50, the wireless sensor device 20b enters an active state 21a, performs sensing on a sensing target 30 at step S51, and transmits sensing data at step S53, and so on. In addition, the wireless sensor device 20b receives, from the host device 10, a command (S61) based on operation control information at step S62 and performs an operation accordingly at step S63.

When the mode of the wireless sensor device 20b is switched to a sleep mode at step S70 and thus enters an inactive state 25a, operation control information (S64, S67) is not received from the host device 10 any longer, so that the operation control information is lost at steps S65 and S68). Even though the operation control information is lost, the host device 10 erroneously recognizes that the operation control information is transmitted. This is an error.

In order to increase the reception success rate by reducing the loss of operation control information and operate the wireless sensor device with low power, a method has been proposed in which the host device transmits a wake-up signal, which commands switching from the sleep mode to the working mode, to the wireless sensor device.

However, due to the characteristics of wireless communication, considerable power is consumed for the operation of a wireless communication module. In order to receive the wake-up signal, the wireless communication module of the wireless sensor device needs to wait the wake-up signal in the working state so that the wake-up signal unexpectedly transmitted is recognized. This is also a problem that is inappropriate for driving the wireless sensor device with low power.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a method of optimally operating a wireless sensor device with low power according to the limit of battery capacity caused by manufacture of the wireless sensor device in a small and slim size.

Further, when the mode of the wireless sensor device is switched to the sleep mode so as to operate the wireless sensor device with low power, operation control information is not received from a host device any longer, so that there is a problem that the operation control information is lost. There is another problem that despite the loss of the operation control information, the host device erroneously recognizes that the operation control information is transmitted. The present disclosure is intended to solve these problems.

Further, in the case of a method in which the host device transmits, to the wireless sensor device, a wake-up signal that commands switching from the sleep mode to the working mode, a wireless communication module of the wireless sensor device waits being always in a working state in order to receive the wake-up signal, resulting a problem that the power of the wireless sensor device is consumed. The present disclosure is intended to solve this problem.

According to an exemplary embodiment of the present invention, a method of controlling a low-power operation of a wireless sensor device includes performing a sensor-active step where the wireless sensor device is active during the time taken for a working mode in which the wireless sensor device performs multiple tasks, and performing a sensor-inactive step where a mode of the wireless sensor device is switched to a sleep mode after the working mode is ended. The performing of the sensor-active step includes receiving, after transmitting sensing data of a sensing target to a host device that monitors and controls the wireless sensor device, operation control information stored in the host device from the host device.

The performing of the sensor-active step includes causing the host device to recognize switching to the working mode of the wireless sensor device on the basis of transmission of the sensing data.

The method of controlling the low-power operation of the wireless sensor device further includes repeatedly operating the wireless sensor device in the working mode and the sleep mode.

The performing of the sensor-active step includes sensing the sensing target, transmitting the sensing data of the sensing target to the host device, and receiving the stored operation control information from the host device after the sensing data is transmitted to the host device.

The method of controlling the low-power operation of the wireless sensor device further includes setting a sensing period for sensing the sensing target. Repeatedly operating of the wireless sensor device in the working mode and the sleep mode is performed in association with the sensing period.

The receiving of the stored operation control information includes receiving the operation control information during a predetermined time limit that is set considering data transmission characteristics of the host device.

The receiving of the stored operation control information includes ending the working mode when there is no data received from the host device during a threshold time that is set for a waiting time for receiving data from the host device.

According to an exemplary embodiment of the present invention, a method of controlling a low-power operation of a wireless sensor device includes performing a control information transmission step where a host device monitoring and controlling the wireless sensor device transmits operation control information stored in the host device to the wireless sensor device as sensing data is received from the wireless sensor device, and performing a control information storage step where the host device stores operation control information for the wireless sensor device as a mode of the wireless sensor device is switched to a sleep mode.

The performing of the control information transmission step includes switching to a working mode of the wireless sensor device being recognized on the basis of transmission of the sensing data from the wireless sensor device.

The performing of the control information transmission step and the performing of the control information storage step are repeated by the host.

The performing of the control information storage step includes switching to the sleep mode being recognized on the basis of a time limit for receiving information that is set in association with transmission of the operation control information according to data transmission characteristics of the host device.

According to an exemplary embodiment of the present invention, a wireless sensor device includes a sensing unit configured to sense a sensing target, a sensor control unit configured to repeatedly operate in between a working mode, in which multiple tasks for transmitting sensing information of the sensing target to a host device are processed, and a sleep mode, in which operation of the wireless sensor device is stopped, and a sensor communication unit configured to transmit and receive data from the host device. The sensor control unit is configured to further receive, after sensing data of the sensing target is transmitted to the host device, operation control information stored in the host device from the host device and processes the operation control information.

The sensor control unit is configured to cause the host device to recognize switching to the working mode on the basis of transmission of the sensing data of the sensing target.

The sensor control unit includes a mode setting unit configured to repeatedly switch the mode between the working mode and the sleep mode in association with a sensing period for sensing the sensing target, and an operation control unit configured to receive the stored operation control information from the host device, and perform an operation according to the operation control information.

The mode setting unit is configured to set a time limit for receiving information considering data transmission characteristics of the host device, and end the working mode on the basis of the time limit for receiving information.

The mode setting unit is configured to set a threshold time for a waiting time for receiving data from the host device, and end the working mode when there is no data received from the host device during the threshold time.

According to an exemplary embodiment of the present invention, a host device monitoring and controlling a wireless sensor device that repeatedly becomes active in association with a working mode and inactive in association with a sleep mode includes a control information storage unit configured to store operation control information for the wireless sensor device, and a control command unit configured to recognize switching to the working mode of the wireless sensor device on the basis of reception of sensing data from the wireless sensor device, and transmit the stored operation control information to the wireless sensor device.

The control command unit is configured to recognize switching to the sleep mode of the wireless sensor device on the basis of a time limit for receiving information that is set considering data transmission characteristics of the host device.

The host device further includes a sensor monitoring unit configured to receive the sensing data from the wireless sensor device, and monitor operation of the wireless sensor device, a user interface configured to provide the sensing data to a user, and receive a control command from the user, and a host communication unit configured to transmit and receive data from the wireless sensor device.

According to an exemplary embodiment of the present invention, a method of controlling low-power operation of a wireless sensor device includes performing a first step where the wireless sensor device is active during the time taken for a working mode in which the wireless sensor device continuously performs multiple tasks, and the wireless sensor device senses a sensing target and transmits sensing data to a host device so that the host device is made to recognize switching to the working mode of the wireless sensor device, performing a second step where the host device recognizes switching to the working mode of the wireless sensor device as the sensing data is received from the wireless sensor device, and the host device transmits, to the wireless sensor device, operation control information stored during the time taken for a sleep mode of the wireless sensor device, performing a third step where the wireless sensor device receives the operation control information and performs the tasks during a time limit for receiving information that is set considering data transmission characteristics of the host device, performing a fourth step where the mode of the wireless sensor device is switched to the sleep mode and the wireless sensor device becomes inactive, and performing a fifth step where the host device stores operation control information for the wireless sensor device as the mode of the wireless sensor device is switched to the sleep mode. Each of the steps is repeatedly performed depending on that the wireless sensor device is active and inactive.

According to the present disclosure, while the battery capacity is minimized for manufacture of the wireless sensor device in a small and slim size, the wireless sensor device operates with low power in a manner that greatly increases the reception success rate of the operation control information from the host device.

Further, it is possible to prevent an error operation that occurs due to loss of operation control information caused by adjustment of a duty cycle for low-power operation.

In particular, in the wireless sensor device operating between the working mode and the sleep mode for low-power operation, the time taken for the working mode of the wireless sensor device is kept to a minimum, so that power consumption is minimized. In addition, when the wireless sensor device transmits information on sensing data, the host device transmits operation control information stored therein to the wireless sensor device. Therefore, while the wireless sensor device operates with minimum power, the reception success rate of the operation control information is maximized. Accordingly, the wireless sensor system efficiently operates.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating an embodiment of operation of a general wireless sensor system in the related art;

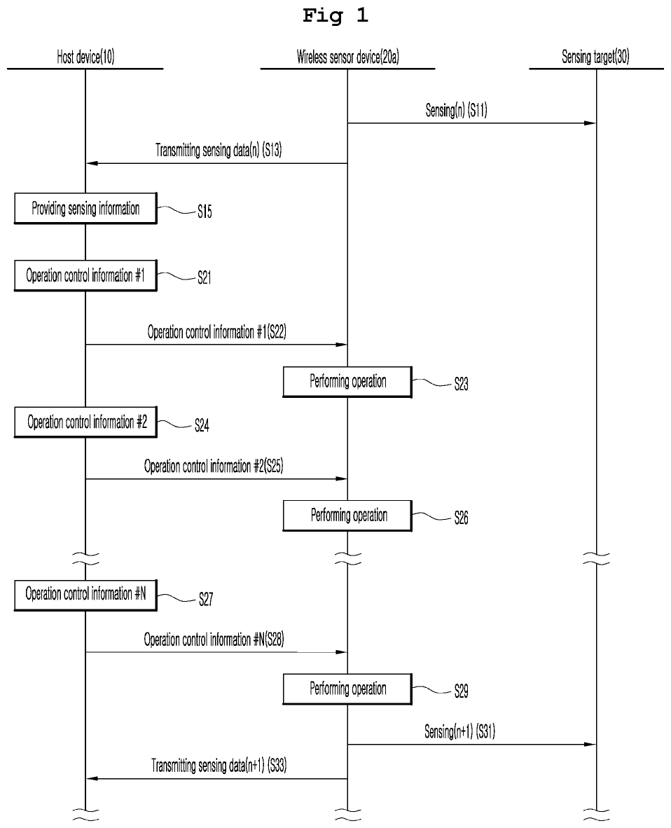

FIG. 2 is a diagram illustrating an embodiment of an operation of adjusting a duty cycle of a wireless sensor system in the related art;

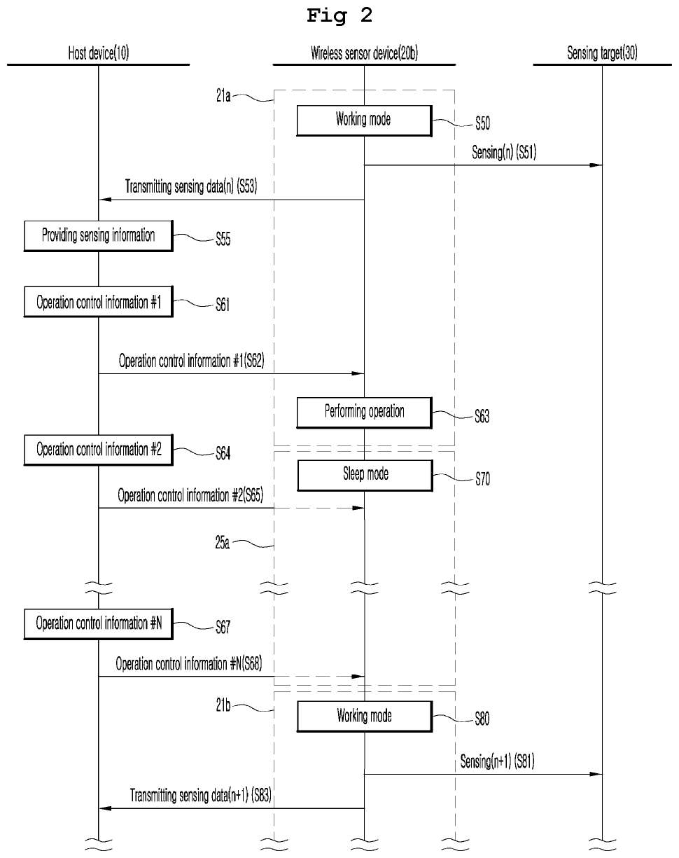

FIG. 3 is a diagram illustrating an embodiment of a wireless sensor system according to the present disclosure;

FIG. 4 is a conceptual diagram illustrating operation of a wireless sensor system according to the present disclosure;

FIGS. 5A and 5B are diagrams illustrating a configuration of an embodiment of a wireless sensor device according to the present disclosure;

FIG. 6 is a diagram illustrating a configuration of an embodiment of a host device according to the present disclosure;

FIG. 7 is a flowchart illustrating an embodiment of a method of controlling low-power operation of a wireless sensor device according to the present disclosure; and

FIG. 8 is a flowchart illustrating an embodiment in which the time taken for a working mode of a wireless sensor device is adjusted, in the present disclosure.

### DETAILED DESCRIPTION OF THE INVENTION

In order to describe the present disclosure, operational advantages of the present disclosure, and the objectives achieved by embodying the present disclosure, exemplary embodiments of the present disclosure will be described hereinbelow.

First, the terms used in the present application are merely used to describe particular embodiments, and are not intended to limit the present disclosure. Further, the singular forms “a”, “an”, and “the” are intended to include the plural forms as well, unless the context clearly indicates otherwise. In addition, in the present application, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

In describing the present disclosure, if it is decided that the detailed description of known function or configuration related to the disclosure makes the subject matter of the disclosure unclear, the detailed description is omitted.

The present disclosure provides a method that fulfills the following: in a wireless sensor device operating between a working mode and a sleep mode for low power operation, the time taken for the working mode of the wireless sensor device is kept minimum, and when the wireless sensor device transmits information on sensing data, a host device transmits operation control information stored therein, whereby the reception success rate of the operation control information is maximized while the wireless sensor device operates with low power.

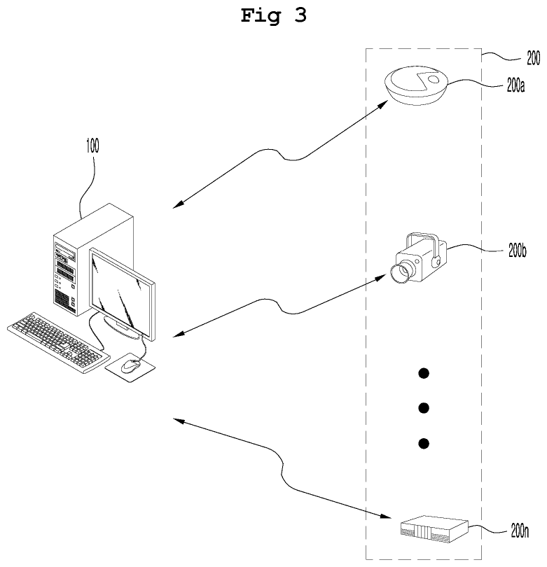

FIG. 3 is a diagram illustrating an embodiment of a wireless sensor system according to the present disclosure.

According to the present disclosure, the wireless sensor system includes a host device 100 and a wireless sensor device 200. The wireless sensor device 200 measures the physical quantity with respect to a sensing target according to various sensing conditions of the sensing target, such as a form, a location, the degree of change, and the like. The host device 100 controls the wireless sensor device by monitoring the same.

In the present disclosure, the types and the forms of the wireless sensor devices 200 may vary according to the sensing target. Therefore, the wireless sensor device 200 is not limited to a particular wireless sensor device. Depending on the sensing function, installation location, the physical quantity with respect to the measurement target, and the like, various wireless sensor devices 200a, 200b, . . . , 200n may be applied. Fundamentally, the wireless sensor device 200 refers to a wireless sensor device 200 that performs data communication with the host device 100 by using a wireless communication method.

Herein, as the wireless communication between the host device and the wireless sensor device, a communication method, such as Zigbee, Bluetooth, Wi-Fi, WiBro, or the like, suitable for the situation may be applied according to the characteristics of transmission data, a wireless communication environment, or the like. The wireless sensor device 200 has a function of being active through operation in a working mode or being inactive through operation in a sleep mode, and operates according to each mode switching.

The host device 100 receives, from the wireless sensor device 200, sensing data sensed from the sensing target. The host device 100 provides the sensing data to a user, or provides the sensing data to a higher-level device that requires the sensing data. Subsequently, the host device 100 transmits operation control information for controlling the wireless sensor device 200 to the wireless sensor device 200, thereby managing and controlling the wireless sensor device 200.

The number of the wireless sensor devices 200 that the host device 100 manages and controls may vary between situation conditions.

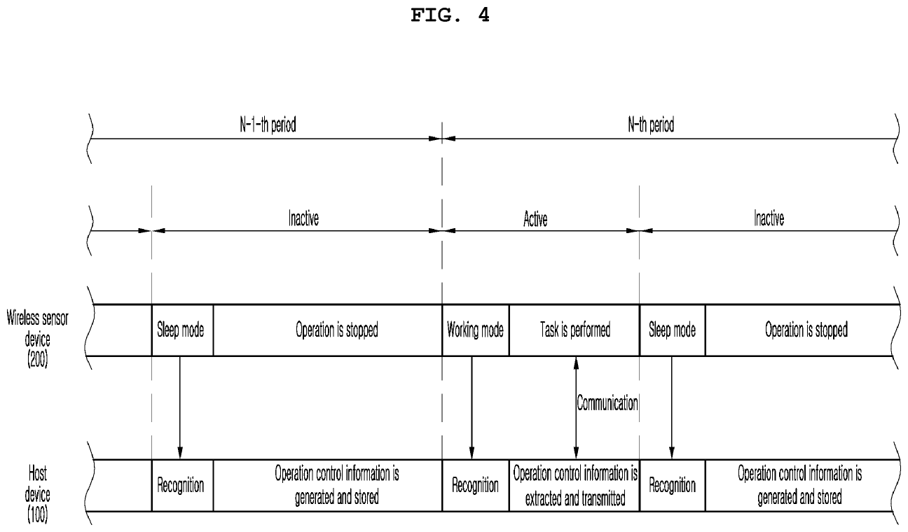

The fundamental concept of the present disclosure applied to such a wireless sensor system will be described with reference to FIG. 4.

In FIG. 4, an operation between one wireless sensor device 200 and the host device 100 is described for convenience of description, and the number of the wireless sensor devices 200 may vary when necessary. In addition, in FIG. 4, the concept of operations in an active state and an inactive state according to a sensing period that is preset considering the characteristics of the device is described, but is not limited thereto. When necessary, rather than regular sensing periods, operations in an irregular active state and an irregular inactive state according to the user's setting or control by the higher-level device may be implemented.

FIG. 4 shows a fundamental operation of the wireless sensor device 200 for each sensing period and a corresponding operation of the host device 100.

In an n−1-th sensing period, the wireless sensor device 200 becomes active, performs an operation, and becomes inactive due to switching to the sleep mode, and thus the wireless sensor device 200 stops all operations. Herein, all components other than the components for mode switching stop operating because power supply is cut off. That is, power supply to all components including a communication module except essential components, such as a timer, and the like, for determining the sensing period of the wireless sensor device 200 is cut off so that power consumption is minimized.

When the mode of the wireless sensor device 200 is switched to the sleep mode and the wireless sensor device 200 becomes inactive, the host device 100 recognizes switching to the sleep mode of the wireless sensor device 200. Herein, switching to the sleep mode of the wireless sensor device 200 is recognized by receiving information on switching to the sleep mode from the wireless sensor device 200, or recognized as the corresponding time has elapsed measured by a timer that the host device 100 has. The timer is to determine the sensing period and is synchronized with the timer of the wireless sensor device 200.

When switching to the sleep mode of the wireless sensor device 200 is recognized, the host device 100 does not maintain communication with the wireless sensor device 200 any longer and operates independently. As the independent operation, when the host device 100 receives operation control information for the wireless sensor device 200 from the user or the higher-level device, the host device 100 stores the operation control information.

As an n-th sensing period begins and the mode of the wireless sensor device 200 is switched to the working mode, the wireless sensor device 200 performs corresponding tasks, such as sensing the sensing target, transmitting sensing data, forming a wireless communication line with the host device, and the like.

Herein, the time taken to maintain the working mode as the wireless sensor device 200 becomes active may be set considering the tasks to be performed, the characteristics of wireless communication with the host device 100, and the like. As the time taken to maintain the working mode has elapsed, the wireless sensor device 200 ends the working mode and the mode is switched to the sleep mode.

The host device 100 may recognize switching to the working mode of the wireless sensor device 200 by receiving a signal indicating switching to the working mode from the wireless sensor device 200. However, preferably, operating in the working mode is recognized by information on sensing data transmitted from the wireless sensor device 200.

When the host device 100 receives the information on the sensing data from the wireless sensor device 200, the host device 100 extracts the stored operation control information and transmits the operation control information to the wireless sensor device 200. As the operation control information is transmitted from the host device 100, the wireless sensor device 200 performs a task of the corresponding operation.

When the mode of the wireless sensor device 200 is switched to the sleep mode, the host device 100 recognizes switching and stores operation control information for the wireless sensor device 200 as an independent operation.

As described above, in the present disclosure, the wireless sensor device repeatedly becomes active and inactive every sensing period. Correspondingly, the host device performs a task corresponding to the active state of the wireless sensor device and an independent task corresponding to the inactive state.

Herein, in order to reduce power usage as much as possible, the wireless sensor device stops supplying power to all components except the essential components for determining the sensing period during the sleep mode. The host device stores the operation control information during the sleep mode of the wireless sensor device in order to prevent the operation control information from being lost due to a failure of transmission of the operation control information caused by interruption to communication with the wireless sensor device. When the mode of the wireless sensor device is switched to the working mode, the stored operation control information is transmitted.

Hereinafter, the wireless sensor device and the host device of the wireless sensor system according to the present disclosure will be described in detail with reference to an embodiment.

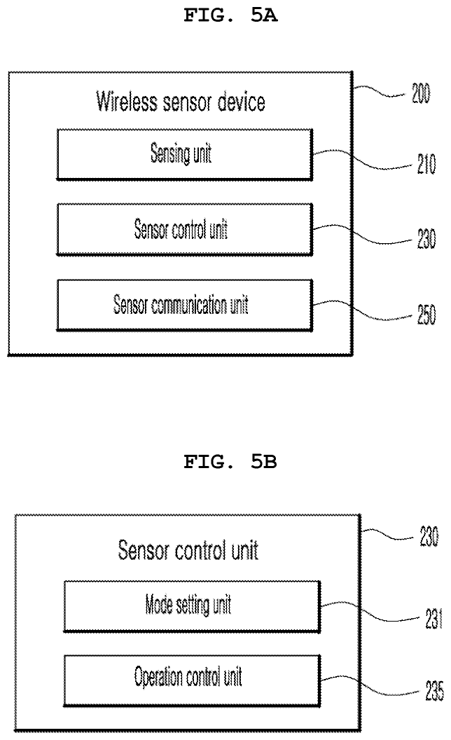

FIGS. 5A and 5B are diagrams illustrating a configuration of an embodiment of a wireless sensor device according to the present disclosure.

Regarding the embodiment of the wireless sensor device 200 according to the present disclosure shown in FIG. 5A, the wireless sensor device 200 may include a sensing unit 210, a sensor control unit 230, a sensor communication unit 250, and the like. When necessary, the wireless sensor device 200 may further include additional components that may be included in known wireless sensor devices. However, a description of the components other than the gist of the present disclosure will be omitted.

The sensing unit 210 senses the sensing target and generates sensing data. A sensor included in the sensing unit 210 may be variously modified according to the sensing target, the physical quantity to be measured, or the like.

*68 The sensor control unit 230 manages and control each component of the wireless sensor device 200. In the present disclosure, the sensor control unit 230 has a function of repeatedly performing switching between the working mode, in which multiple tasks for transmitting the sensing information of the sensing target to the host device are processed, and the sleep mode, in which the operation of the wireless sensor device is stopped. Preferably, the sensing period for sensing the sensing target is set, and mode switching is repeatedly performed in association with the sensing period.

The sensor communication unit 250 transmits and receives data from the host device 100 through wireless communication. Herein, various wireless communication methods, such as Zigbee, Bluetooth, Wi-Fi, WiBro, and the like, may be applied considering the characteristics of the host device 100 and the wireless sensor device 200, an installation environment, and the like.

Regarding the sensor control unit 230 in detail, which is the main feature of the wireless sensor device 200 according to the present disclosure, the sensor control unit 230 may receive the stored operation control information from the host device 100 during the working mode and may process the task corresponding to the operation control information. The sensor control unit 230 may further include detailed components as shown in FIG. 5B.

A mode setting unit 231 may repeatedly switch the mode of the wireless sensor device 200 between the working mode and the sleep mode in association with the sensing period. An operation control unit 235 receives the stored operation control information from the host device 100 as the mode setting unit 231 switches the mode to the working mode. As the operation control information is received, the operation control unit 235 performs a task corresponding to the operation control information.

Preferably, as the mode is switched to the working mode, the operation control unit 235 transmits information on sensing data to the host device 100. As the information on sensing data is transmitted, the stored operation control information is received from the host device 100.

More preferably, starting from transmission of the sensing data, the stored operation control information is received from the host device 100. During any other time period, the operation control information is not received from the host device 100.

The task performed by the operation control unit 235 according to the operation control information may include various tasks, such as setting the sensing period, setting and adjusting sensing sensitivity and wireless communication, synchronization of the timer determining the sensing period, and the like.

Preferably, the mode setting unit 231 sets the time limit for receiving information considering the data transmission characteristics of the host device 100, such as a communication method, a packet format, data transmission rate, and the like. When the time limit for receiving information has elapsed in the middle of the working mode, the mode setting unit 231 ends the working mode. To this end, the mode setting unit 231 may include a timer that determines whether the time limit for receiving information has elapsed. The timer of the mode setting unit 231 is synchronized with the timer of the host device 100, so the host device 100 recognizes that the mode of the wireless sensor device 200 is switched to the sleep mode due to the end of the working mode caused by the end of the time limit for receiving information.

Further, the mode setting unit 231 may set a threshold time for the waiting time for receiving data from the host device 100. When there is no data received from the host device 100 during the threshold time, the mode setting unit 231 ends the working mode and switches the mode to the sleep mode. Accordingly, it is possible to prevent unnecessary power consumption that is caused by maintaining communication even when there is no data transmitted from the host device 100.

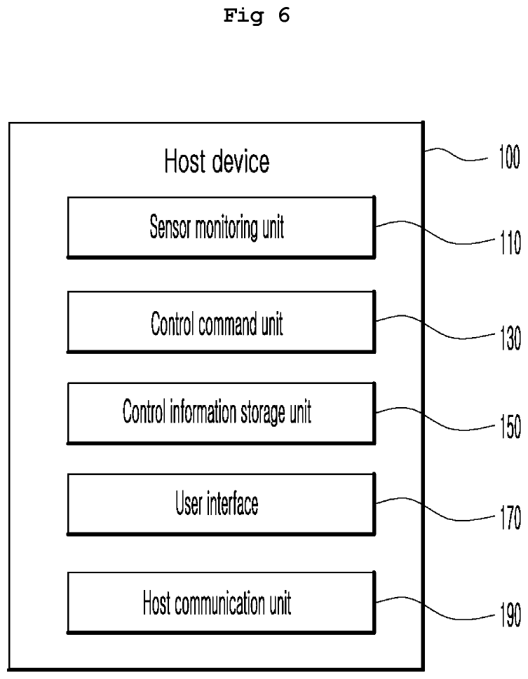

FIG. 6 is a diagram illustrating a configuration of an embodiment of a host device according to the present disclosure.

In the present disclosure, the host device 100 is a device that is capable of monitoring and controlling the wireless sensor device 200 that repeatedly becomes active in the working mode and inactive as the mode is switched to the sleep mode.

The host device 100 schematically may include a sensor monitoring unit 110, a control command unit 130, a control information storage unit 150, a user interface 170, a host communication unit 190, and the like. In addition, additional components capable of remotely monitoring and controlling the multiple wireless sensor devices 200 may be included, but a description of components other than the characteristic components of the present disclosure will be omitted.

The sensor monitoring unit 110 has a function of receiving the sensing data from the wireless sensor device 200 and monitoring the operation of the wireless sensor device 200. Depending on the situation, being in in conjunction with the higher-level device, the sensor monitoring unit 110 may convert the sensing data of the wireless sensor device 200 into data in an appropriate format and provide the resulting data to the higher-level device, and may receive operation control information corresponding thereto.

Being in conjunction with the sensor monitoring unit 110, the user interface 170 may provide the sensing data of the wireless sensor device 200 to the user and may receive operation control information for the wireless sensor device 200 from the user. Herein, the user interface 170 may function as an interface that is connected with the user's terminal.

In addition, the control information storage unit 150 generates and stores operation control information for the wireless sensor device 200. Herein, the operation control information may be information that is generated by being received from the user through the user interface 170 or from the higher-level device. In particular, the control information storage unit 150 stores the operation control information during the sleep mode of the wireless sensor device 200.

The control command unit 130 recognizes the switching of the mode of the wireless sensor device 200 between the working mode and the sleep mode. As the mode is switched to the sleep mode, the control command unit 130 supports the control information storage unit 150 to store the operation control information. As the mode is switched to the working mode, the control command unit 130 transmits the operation control information stored in the control information storage unit 150 to the wireless sensor device 200.

Herein, regarding the recognition of switching to the working mode, the control command unit 130 may recognize switching by receiving information on switching to the working mode from the wireless sensor device 200. Preferably, the control command unit 130 recognizes transmission of the sensing data from the wireless sensor device 200, thereby recognizing switching to the working mode. In addition, regarding the recognition of switching to the sleep mode, the control command unit 130 may recognize switching by receiving information on switching to the sleep mode from the wireless sensor device 200. Preferably, the control command unit 130 recognizes the time limit for receiving information, which is set in association with the end of the working mode, through the timer, or the like, thereby recognizing switching to the sleep mode.

In addition, the control information storage unit 150 stores, on the basis of the recognition of switching to the sleep mode by the control command unit 130, the operation control information during the sleep mode of the wireless sensor device 200. When the mode is switched to the working mode according to the subsequent sensing period of the wireless sensor device 200, the control command unit 130 extracts the operation control information stored in the control information storage unit 150 and transmits the operation control information to the wireless sensor device 200.

In the present disclosure, through the wireless sensor system composed of the host device 100 and the wireless sensor device 200 described above, the power of the wireless sensor device is used with maximum efficiency, and the operation control information from the host device 100 is prevented from being lost, thereby planning stable operation of the entire system. Hereinafter, a method of controlling low-power operation of a wireless sensor device through the wireless sensor system according to the present disclosure will be described.

The method of controlling low-power operation of the wireless sensor device through the wireless sensor system according to the present disclosure may be divided, on the basis of a performer that performs each process, into a method of controlling low-power operation according to the operation of the wireless sensor device 200 and a method of controlling low-power operation according to the operation of the host device 100.

First, the method of controlling low-power operation according to the operation of the wireless sensor device 200 schematically includes: a sensor-active step where the wireless sensor device 200 is active during the time taken for the working mode in which the wireless sensor device 200 continuously performs multiple tasks; and a sensor-inactive step where the mode of the wireless sensor device 200 is switched to the sleep mode as the working mode is ended. The wireless sensor device 200 repeatedly performs the sensor-active step and the sensor-inactive step.

Herein, during the sensor-active step, as the wireless sensor device 200 transmits sensing data of the sensing target to the host device 100, the wireless sensor device 200 receives the stored operation control information from the host device 100.

In addition, regarding the method of controlling low-power operation according to the operation of the host device 100, a description of the basic operation that the host device 100 monitors and manages the wireless sensor device 200 will be omitted and the features of the present disclosure will be schematically described. The method includes: a control information transmission step where as the host device 100 receives the sensing data from the wireless sensor device 200, the host device 100 transmits the stored operation control information to the wireless sensor device 200; and a control information storage step where, as the mode of the wireless sensor device 200 is switched to the sleep mode, the host device 100 stored operation control information for the wireless sensor device 200. The host device 100 repeatedly performs the control information transmission step and the control information storage step.

As described above, in the method of controlling low-power operation of the wireless sensor device according to the present disclosure, the wireless sensor device repeatedly becomes active in association with the working mode and inactive in association with the sleep mode, thereby minimizing power usage in the sleep mode. Herein, during the sleep mode of the wireless sensor device, the host device stores the operation control information. When the mode is switched to the working mode, the host device transmits the stored operation control information to the wireless sensor device.

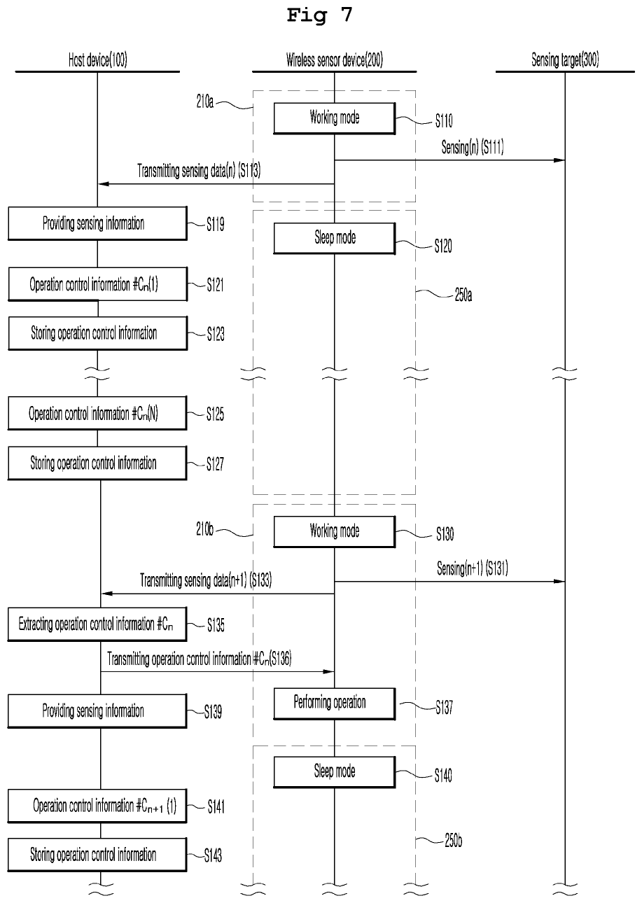

Hereinafter, the method of controlling low-power operation of the wireless sensor device according to the present disclosure will be described in more detail. The method of controlling low-power operation of the wireless sensor device according to the present disclosure is implemented according to the interworking operation between the host device 100 and the wireless sensor device 200. Synthesizing the operations of the host device 100 and the wireless sensor device 200, an embodiment of the method of controlling low-power operation of the wireless sensor device according to the present disclosure will be described with reference to FIG. 7.

In the embodiment shown in FIG. 7, the wireless sensor device 200 sets the sensing period in which the sensing target 300 is sensed, and the wireless sensor device 200 repeatedly becomes active and inactive in association with the sensing period.

As an n-th sensing period begins, the wireless sensor device 200 switches the mode to the working mode at step S110, becomes active (210a), and performs a task accordingly. The wireless sensor device 200 performs n-th sensing on the sensing target 300 at step S111 and transmits sensing data to the host device 100 at step S113.

As the sensing data is transmitted from the wireless sensor device 200, the host device 100 provides the sensing data to the user or the higher-level device at step S119.

As the sensing data is transmitted, the wireless sensor device 200 receives the stored operation control information from the host device 100. When the operation control information is not transmitted, the wireless sensor device 200 ends the working mode, switches the mode to the sleep mode at step S120, and thus enters an inactive state (250a). As the mode is switched to the sleep mode, power supply to power components other than the essential components for determining the sensing period is cut off to stop operation.

The host device 100 recognizes switching to the sleep mode of the wireless sensor device 200 and does not maintain communication any longer while the wireless sensor device 200 is in the inactive state. During the sleep mode, when operation control is input from the user or the higher-level device, the host device 100 generates operation control information Cₙ1) at step S121 and stores the generated operation control information Cₙ(1) at step S123. As shown in FIG. 7, operation control may be input multiple times from the user or the higher-level device. Correspondingly, the host device 100 generates operation control information Cₙ(N) at step S125 for the additionally input operation control, and stores the resulting information at step S127.

That is, in a state where communication is lost due to switching to the sleep mode of the wireless sensor device 200, the host device 100 stores the operation control information for the wireless sensor device 200 until the subsequent switching to the working mode.

As an n+1-th sensing period begins, the wireless sensor device 200 switches the mode to the working mode at step S130, enters an active state, and performs a task accordingly. As described above, the wireless sensor device 200 performs n+1-th sensing on the sensing target 300 at step S131 and transmits corresponding sensing data to the host device 100 at step S133.

The host device 100 recognizes switching to the working mode of the wireless sensor device 200. Herein, transmission of n+1-th sensing data is recognized, whereby switching to the working mode is recognized. As the sensing data is transmitted from the wireless sensor device 200, the host device 100 extracts the stored operation control information Cₙ and transmits the resulting information to the wireless sensor device 200 at step S136. The wireless sensor device 200 performs an operation at step S137 in association with the operation control information transmitted from the host device 100.

When the wireless sensor device 200 switches the mode back to the sleep mode at step S140 and enters an inactive state (250b), the host device 100 recognizes switching to the sleep mode of the wireless sensor device 200, does not maintain communication any longer, and performs an independent task. As the independent task, the host device 100 generates and stores operation control information Cₙ₊₁, and waits until the wireless sensor device 200 switches the mode to the working mode as an n+2-th sensing period begins.

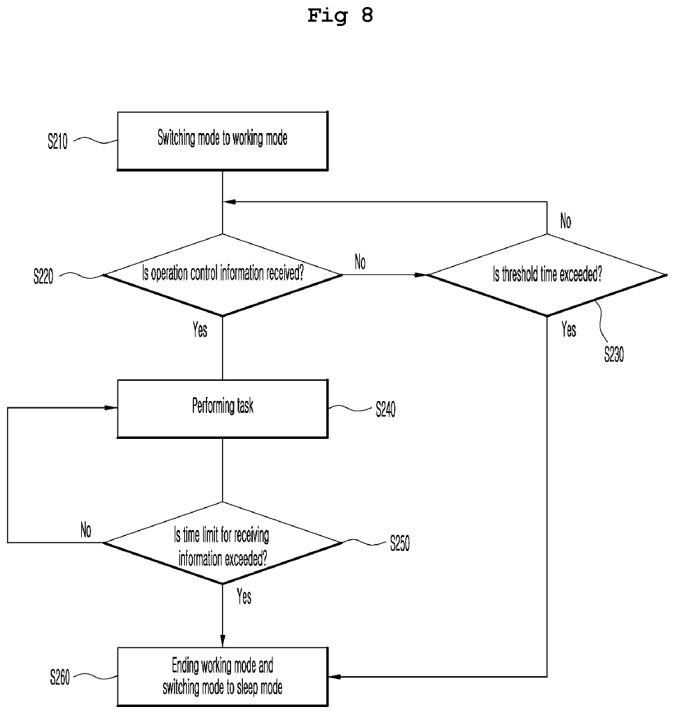

Further, for more efficient operation, the time taken to maintain the active state during the working mode of the wireless sensor device may be set. FIG. 8 is a flowchart illustrating an embodiment in which the time taken for a working mode of a wireless sensor device is adjusted, in the present disclosure.

As the mode is switched to the working mode at step S210, when the wireless sensor device 200 enters an active state, the wireless sensor device 200 identifies whether the operation control information is received from the host device 100 at step S220 while performing multiple preset tasks in the working mode.

In the wireless sensor device 200, a threshold time for the waiting time for receiving data from the host device 100 is set. Herein, the threshold time may be appropriately set by the user or the like, considering the data transmission characteristics of the host device.

When there is no data received from the host device 100 during the threshold time, the wireless sensor device 200 determines whether the threshold time is exceeded at step S230. When the threshold time is exceeded, the wireless sensor device 200 ends the working mode and switches the mode to the sleep mode at step S260.

In addition, the time limit for receiving operation control information from the host device 100 may be set in the wireless sensor device 200. Herein, the time limit for receiving information may be set considering the characteristics of data transmission with the host device 100.

For example, the time limit for receiving information may be set considering various factors, such as what type the wireless communication method is, what type the data packet is, what the rate of communication between the host device and the wireless sensor device is, and so on. Further, a predetermined additional time may be considered for stability of data reception. The time limit for receiving information may be automatically set considering various conditions or may be set by the user.

When the wireless sensor device 200 receives the operation control information from the host device 100 at step S220, while performing a task corresponding to the operation control information at step S240, the wireless sensor device 200 determines whether the time limit for receiving information is exceeded at step S250. When the time limit for receiving information is not exceeded, receiving of the operation control information keeps performing. However, when the time limit for receiving information is exceeded, the wireless sensor device 200 ends the working mode, switches the mode to the sleep mode at step S260, and enters the inactive state.

As described, when the time limit for receiving information is exceeded, the data transmitted from the host device may be lost. Therefore, the wireless sensor device 200 may transmit information on exceeding the time limit for receiving information to the host device 100. Alternatively, the wireless sensor device 200 may share the time limit for receiving information set in the wireless sensor device 200 with the host device 100 and the host device 100 recognizes that the time limit for receiving information is exceeded through synchronization of the timers installed on the host device 100 and the wireless sensor device 200, respectively.

Further, the method of controlling low-power operation of the wireless sensor device according to the present disclosure may be implemented by performing each step through the operation of a computer program. To this end, according to the present disclosure, the wireless sensor device or the host device may include a storage medium on which the computer program performing the steps proposed in the method of controlling low-power operation of the wireless sensor device is stored, and a computing element included in the wireless sensor device or the host device loads and drives the computer program stored on the storage medium, thereby implementing the present disclosure. Preferably, the wireless sensor device or the host device is equipped with firmware that operates by driving the computer program. The steps proposed in the method of controlling low-power operation of the wireless sensor device may be performed through the firmware, thereby implementing the present disclosure.

According to the present disclosure, while the battery capacity is minimized for manufacture of the wireless sensor device in a small and slim size, the wireless sensor device operates with low power in a manner that greatly increases the reception success rate of the operation control information from the host device.

In particular, in the wireless sensor device operating between the working mode and the sleep mode for low-power operation, the time taken for the working mode of the wireless sensor device is kept to a minimum, so that power consumption is minimized. In addition, the host device stores operation control information during the time taken for the sleep mode of the wireless sensor device, and when the mode of the wireless sensor device is switched to the working mode, the host device transmits the stored operation control information to the wireless sensor device. Therefore, while the wireless sensor device operates with minimum power, the reception success rate of the operation control information is maximized. Accordingly, the wireless sensor system efficiently operates.

The above description is merely intended to exemplarily describe the technical idea of the present disclosure, and those skilled in the art will appreciate that various changes and modifications are possible without departing from the essential features of the present disclosure. Therefore, the embodiments disclosed in the present disclosure are not intended to restrict the technical idea of the present disclosure and are merely intended to describe the present disclosure, and the technical idea of the present disclosure is not limited by those embodiments. The scope of the present disclosure should be defined by the accompanying claims, and the technical idea of all equivalents thereof should be construed as being included in the scope of the present disclosure.

What is claimed is:

1. A method of controlling a low-power operation of a wireless sensor device, the method comprising:
performing a sensor-active step where the wireless sensor device is active during the time taken for a working mode in which the wireless sensor device performs multiple tasks; and
performing a sensor-inactive step where a mode of the wireless sensor device is switched to a sleep mode after the working mode is ended,
wherein the performing of the sensor-active step includes receiving, after transmitting sensing data of a sensing target to a host device that monitors and controls the wireless sensor device, operation control information stored in the host device from the host device.

2. The method of claim 1,
wherein the performing of the sensor-active step includes causing the host device to recognize switching to the working mode of the wireless sensor device on the basis of transmission of the sensing data.

3. The method of claim 1, further comprising:
repeatedly operating the wireless sensor device in the working mode and the sleep mode.

4. The method of claim 1, wherein the performing of the sensor-active step comprises:
sensing the sensing target;
transmitting the sensing data of the sensing target to the host device; and
receiving the stored operation control information from the host device after the sensing data is transmitted to the host device.

5. The method of claim 3, further comprising:
setting a sensing period for sensing the sensing target,
wherein repeatedly operating of the wireless sensor device in the working mode and the sleep mode is performed in association with the sensing period.

6. The method of claim 4,
wherein the receiving of the stored operation control information includes receiving the operation control information during a predetermined time limit that is set considering data transmission characteristics of the host device.

7. The method of claim 4,
wherein the receiving of the stored operation control information includes ending the working mode when there is no data received from the host device during a threshold time that is set for a waiting time for receiving data from the host device.

8. A method of controlling a low-power operation of a wireless sensor device, the method comprising:
performing a control information transmission step where a host device monitoring and controlling the wireless sensor device transmits operation control information stored in the host device to the wireless sensor device as sensing data is received from the wireless sensor device; and
performing a control information storage step where the host device stores operation control information for the wireless sensor device as a mode of the wireless sensor device is switched to a sleep mode.

9. The method of claim 8,
wherein the performing of the control information transmission step includes switching to a working mode of the wireless sensor device being recognized on the basis of transmission of the sensing data from the wireless sensor device.

10. The method of claim 8,
wherein the performing of the control information transmission step and the performing of the control information storage step are repeated by the host.

11. The method of claim 8,
wherein the performing of the control information storage step includes switching to the sleep mode being recognized on the basis of a time limit for receiving information that is set in association with transmission of the operation control information according to data transmission characteristics of the host device.

12. A wireless sensor device comprising:
a sensing unit configured to sense a sensing target;
a sensor control unit configured to repeatedly operate in between a working mode, in which multiple tasks for transmitting sensing information of the sensing target to a host device are processed, and a sleep mode, in which operation of the wireless sensor device is stopped; and
a sensor communication unit configured to transmit and receive data from the host device,
wherein the sensor control unit is configured to further receive, after sensing data of the sensing target is transmitted to the host device, operation control information stored in the host device from the host device and processes the operation control information.

13. The wireless sensor device of claim 12,
wherein the sensor control unit is configured to cause the host device to recognize switching to the working mode on the basis of transmission of the sensing data of the sensing target.

14. The wireless sensor device of claim 12,
wherein the sensor control unit comprises:
a mode setting unit configured to repeatedly switch the mode between the working mode and the sleep mode in association with a sensing period for sensing the sensing target; and
an operation control unit configured to receive the stored operation control information from the host device, and perform an operation according to the operation control information.

15. The wireless sensor device of claim 14,
wherein the mode setting unit is configured to set a time limit for receiving information considering data transmission characteristics of the host device, and end the working mode on the basis of the time limit for receiving information.

16. The wireless sensor device of claim 13,
wherein the mode setting unit is configured to set a threshold time for a waiting time for receiving data from the host device, and end the working mode when there is no data received from the host device during the threshold time.

17. A host device monitoring and controlling a wireless sensor device that repeatedly becomes active in association with a working mode and inactive in association with a sleep mode, the host device comprising:
a control information storage unit configured to store operation control information for the wireless sensor device; and
a control command unit configured to recognize switching to the working mode of the wireless sensor device on the basis of reception of sensing data from the wireless sensor device, and transmit the stored operation control information to the wireless sensor device.

18. The host device of claim 17,
wherein the control command unit is configured to recognize switching to the sleep mode of the wireless sensor device on the basis of a time limit for receiving information that is set considering data transmission characteristics of the host device.

19. The host device of claim 17, further comprising:
a sensor monitoring unit configured to receive the sensing data from the wireless sensor device, and monitor operation of the wireless sensor device;
a user interface configured to provide the sensing data to a user, and receive a control command from the user; and
a host communication unit configured to transmit and receive data from the wireless sensor device.

20. A method of controlling low-power operation of a wireless sensor device, the method comprising:
performing a first step where the wireless sensor device is active during the time taken for a working mode in which the wireless sensor device continuously performs multiple tasks, and the wireless sensor device senses a sensing target and transmits sensing data to a host device so that the host device is made to recognize switching to the working mode of the wireless sensor device;
performing a second step where the host device recognizes switching to the working mode of the wireless sensor device as the sensing data is received from the wireless sensor device, and the host device transmits, to the wireless sensor device, operation control information stored during the time taken for a sleep mode of the wireless sensor device;
performing a third step where the wireless sensor device receives the operation control information and performs the tasks during a time limit for receiving information that is set considering data transmission characteristics of the host device;
performing a fourth step where the mode of the wireless sensor device is switched to the sleep mode and the wireless sensor device becomes inactive; and
performing a fifth step where the host device stores operation control information for the wireless sensor device as the mode of the wireless sensor device is switched to the sleep mode,
wherein each of the steps is repeatedly performed depending on that the wireless sensor device is active and inactive.
